(19) United States
(12) Patent Application Publication
(10) Pub. No.: US 2016/0253502 A1
(43) Pub. Date: Sep. 1, 2016

(54) One-Time Power-On Password

(71) Applicant: HEWLETT-PCKARD DEVELOPMENT COMPANY, L.P., Houston, TX (US)

(72) Inventor: HELIO MANUEL MEALHA MARTINS, PACO DE ARCOS (PT)

(73) Assignee: Hewlett-Packard Development Company, L.P., Houston, TX (US)

(21) Appl. No.: 14/907,971

(22) PCT Filed: Sep. 30, 2013
(86) PCT No.: PCT/US2013/062538

§ 371 Date: Jan. 27, 2016

(51) Int. Cl. G06F 21/57; G06F 21/41

(52) U.S. Cl. CPC G06F 21/575; G06F 21/41

(57) ABSTRACT

Examples of a one-time power-on password are disclosed, in one example implementation according to aspects of the present disclosure, a computing device may include a processor and a memory. Additionally, the computing device may include a one-time power-on password module stored in the memory and executing on the processor to store a one-time power-on password for booting-up the computing device; to prompt a user of the computing device to enter the one-time power-on password, and to disable the prompt for subsequent boot-ups when the user enters the one-time power-on password. A boot loader module may also be stored in the memory and executing on the processor to boot-up the computing device in response to the user entering the one-time power-on password.

### BACKGROUND

As computing devices, such as laptops, notebooks, tablet computers, smart phones, etc., have decreased in price and increase in popularity, manufacturers and/or suppliers of such computing devices have begun giving away or selling the computing devices at substantial discounts when the purchaser is also purchasing services such as Internet connectivity.

### BRIEF DESCRIPTION OF THE DRAWINGS

The following detested description references the drawings, in which:

FIG. 1 illustrates a block diagram of a computing device bootable with a one-time power-on password according to examples of the present disclosure;

FIG. 2 illustrates a flow diagram of a method for booting a computing device with a one-time power-on password according to examples of the present disclosure; and

FIG. 3 illustrates few diagram of a method for booting a computing device with a one-time power-on password according to examples of the present disclosure.

### DETAILED DESCRIPTION

As computing devices, such as laptops, notebooks, tablet computers, smart phones, etc., have become more economical, telecommunications companies have begun providing significantly discounted or “free” computing devices as an incentive to customers who utilize the telecommunications company's Internet services, for example. Similarly, a telecommunications company may offer the internet service at a discounted price if a user purchases a certain computing device. The telecommunications company may desire to provide a way for a new user to activate their service and/or computing device once the user receives it. This allows the telecommunications company to know when the user receives the device and service and begins using it.

One previous solution is for the telecommunications company to secure the computing device with a power-on or boot-up password that the user most enter upon powering-on or booting-up the computing device. In this case, the user must contact the telecommunications company, such as by telephone, to receive the password thus informing the telecommunications company that the user has received and is using the device and the service. Once entered, the user would be able to use the computing device. However, the user would be required to enter the password each and every time the user booted-up the computing device. The user may also forget the password. Alternatively, the telecommunications company may instruct the user on how to disable the boot-up password, either over the phone or through written instruction. However, some users may not have the technical know-how to perform such an action. Moreover, each course of action Is problematic because of the voluminous number of technical support calls that would be generated.

Various embodiments will be described below by referring to several examples of a one-time power-on password. For example, a computing device may be secured with a one-time power-on password. When the computing device is booted-up, the user may be prompted to enter the one-time power-on password. After being entered, the one-time power-on password is disabled, thereby enabling the user to boot the device subsequently without needing to supply the password or without needing to deactivate it manually.

In some implementations, the one-time power-on password will enable a telecommunications company to know when the user is activating the device (by detecting that the customer calls in to initially ask for the one-time power-on password). The one-time power-on password also prevents initial unauthorized use of the computing device. Additionally, the one-time power-on password disables the continued requirement to enter a password upon booting-up the computing device. The one-time power-on password is also very low cost and utilizes very little in the way of programming of the computing device. These and other advantages will be apparent from the description that follows.

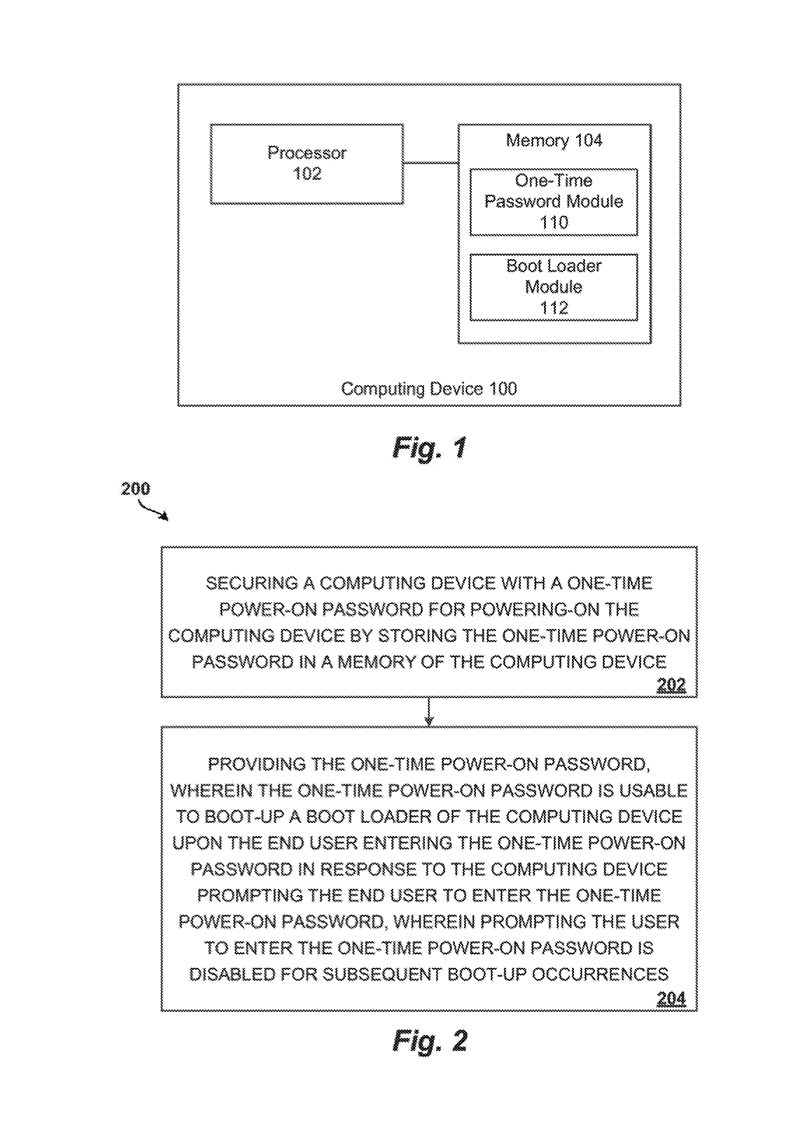

FIG. 1 illustrates a block diagram of a computing device 100 bootable with a one-time power-on password according to examples of the present disclosure. It should be understood that the computing device 100 may include any appropriate type of computing device, including for example smartphones, tablets, desktops, laptops, workstations, servers, smart monitors, smart televisions, digital signage, scientific Instruments, retail point of sate devices, video walls, imaging devices, peripherals, or the like.

The computing device 100 may include a processor 102 that may be configured to process Instructions. The Instructions may fee stored on a non-transitory tangible computer-readable storage medium, such as memory device 104, or on a separate device (not shown), or on any other type of volatile or non-volatile memory that stores instructions to cause a programmable processor to perform the techniques described herein. Alternatively or additionally, the computing, device 100 may include dedicated hardware, such as one or more integrated circuit. Application Specific integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

The computing device 100 may further include various Instructions in the form of modules stored in the memory 104 and executing on the processor 102. These modules may Include a one-time password module 110 and a boot loader module 112. Other modules may also be utilized as will be discussed further below in other examples. Moreover, It should be understood that FIG. 1 merely illustrates one example of an implementation of a one-time power-on password. In other examples, the modules discussed herein may not be stored in the memory 104 or executing on the processor 102, but rather may be stored In and executed on dedicated or specialized hardware as appropriate.

The one-time password module 110 stores a one-time power-on password for securing the computing device 100. The one-time power-on password secures fie computing device 100 by preventing the computing device 100 from fully booting-up until the one-time power-on password is entered. The one-time password module 110 may be loaded with the one-time power-on password by a provider of the computing device (such as a manufacturer of the computing device or by a third-party supplier of the computing device such as a telecommunications company).

Additionally, a user of the computing device 100 may setup a one-time power-on password through a BIOS setup utility (BSU) if available. In this example, the user may access the BSU by pressing a certain key (i.e., F2, F10, F12, Delete, etc.) a few seconds after power-on the computing device 100. If this is done, the user may enter the BSU, which will permit the user to configure several options, including the one-time power-on password. The user may be prevented from accessing the BSU, for example, by a BIOS access password that was previously setup, or by a power-on password (or a one-time power-on password) that was previously setup. The one-time power-on password may also be set remotely, such as through a network. The one-time power-on password may be unique to the computing device 100.

The one-time power-on password may be of two different types: exclusive and non-exclusive, in an implementation utilizing an exclusive one-time power-on password, the particular string of characters that consists of the successfully entered password could not be used again after it is deactivated. In this case, the particular password that was successfully entered into the one-time password module 110 may be stored in the memory 104. The memory 104 will be checked against future password load attempts, and if the password already exists in the memory, then the computing device 100 will not permit the load of the same password into the one-time password module. This may protect against fraud by preventing the same password from being reloaded or reused in the computing device 100. In an implementation utilizing a non-exclusive power-on password, the particular string of characters that consists of the successfully entered password could be used again after it Is deactivated.

Upon powering on the computing device 100 for the first time, an end user of the computing device will be prompted to enter the one-time power-on password. Without the one-time power-on password being entered successfully, the computing device 100 is prevented from booting up. The end user may receive the one-time power-on password from the provider of the computing device, such as by calling the provider to receive the one-time power-on password.

Once the end user has the one-time power-on password, the end user may enter the one-time power-on password on the computing device 100, such as through an attached keyboard or other suitable input device when prompted to enter the one-time power-on password by the computing device. The one-time password module 110 may receive the one-time power-on password entered by the end user and verify the end user-entered one-time power-on password against the one-time power-on password securing the computing device 100. If the one-time power-on passwords do riot match, the end user may be prompted to enter the one-time power-on password again, the computing device 100 may turn off, etc.

However, if the one-time power-on passwords do match, the one-time password module 110 may cause the boot loader module 112 to boot-up the computing device 100. For example, once the one-time power-on password is entered, and the password matches the previously secured one-time power-on password loaded in fie one-time password module 110, the computing device 100 may proceed with a normal power-on and boot-up process, facilitated by the boot loader 112. Moreover, the one-time password module 110 disables the one-time boot-up password prompt for subsequent boot-up attempts when the user successfully enters the one-time power-on password.

In one example, the boot loader 112 may be a basic input/output system (BIOS) or other similar boot loader, which may load system drivers, initiate an operating system, and perform other suitable tasks. The boot loader may include a boot loader set up utility (such as a BIOS setup utility (BSU)) to configure a power-on password. For example, a user may configure the power-on password by type (such as permanent, one-time exclusive, or one-time non-exclusive) or by welcome message—a message that the user will see when prompted to enter the one-time password (e.g., “To activate your PC, please call (212) 555-1212 and enter the password provided.”).

FIG. 2 illustrates a flow diagram of a method 200 for booting a computing device with a one-time power-on password according to examples of the present disclosure. The method 200 may be executed, for example, by a computing system and/or a computing device such as the computing device 100 of FIG. 1.

In one example, the method 200 may include: securing a computing device with a one-time power-on password for booting-up the computing device by storing the one-time power-on password in a memory of the computing device (block 202); and providing the one-time power-on password, wherein the one-time power-on password is usable to boot-up a hoof loader of the computing device upon the end user entering the one-time power-on password in response to the computing device prompting the end user to enter the one-time power-on password, wherein prompting the user to enter the one-time power-on password is disabled for subsequent boot-up occurrences(block 204).

At block 202, the method 200 may include securing a computing device with a one-time power-on password for booting-up the computing device by storing the one-time power-on password in a memory of the computing device. In one example, a vendor or third-party (such as a manufacturer of the computing device or a telecommunications company providing the computing device) may secure the computing device with a one-time power-on password. The vendor or third-party may secure a group or batch of computing devices at the same time (or nearly the same time), with each computing device of the group or batch receiving a unique one-time power-on password. The one-time power-on password: (or passwords) may be saved so that they may be provided to an end user of the computing device. The method 200 may continue to block 204.

At block 204, the method 200 may include providing the one-time power-on password, wherein the one-time power-on password is usable to boot-up a boot loader of the computing device upon the end user entering the one-time power-on password in response to the computing device prompting the end user to enter the one-time power-on password, wherein prompting the user to enter the one-time power-on password is disabled for subsequent boot-up occurrences. When the computing device is first powered-on by an end user, the computing device is prevented from: booting-up until the one-time power-on password is entered. The end user may receive the one-time power-on password from the provider of the computing device (such as the vendor or a third-party such as a telecommunications company) when the computing device was received. The end user may also receive the one-time power-on password by calling the provider of the computing device to acquire the password. The provider of the computing device may provide the one-time power-on password to the end user in any appropriate way.

Once the one-time power-on password is provided, the end user may enter the one-time power-on password on the computing device, such as through an attached keyboard or other input device. Once the one-time power-on password is entered on the computing device, the one-time power-on password is disabled such that it will not be displayed in during future or subsequent power-on attempts. Additionally, after the one-time power-on password is entered on the computing device, the computing device may continue to boot-up a boot loader of the computing device, and the computing device may continue to boot-up normally.

The method 200 may also include prompting the user to enter the one-time power-on password. Moreover the computing device may be prevented from booting up when no one-time power-on password is entered or when the one-time power-on password is entered incorrectly.

Additional processes also may be included, and it should be understood that the processes depicted in FIG. 2 represent illustrations, and that other processes may be added or existing processes may be removed, modified, or rearranged without departing from the scope and spirit of the present disclosure.

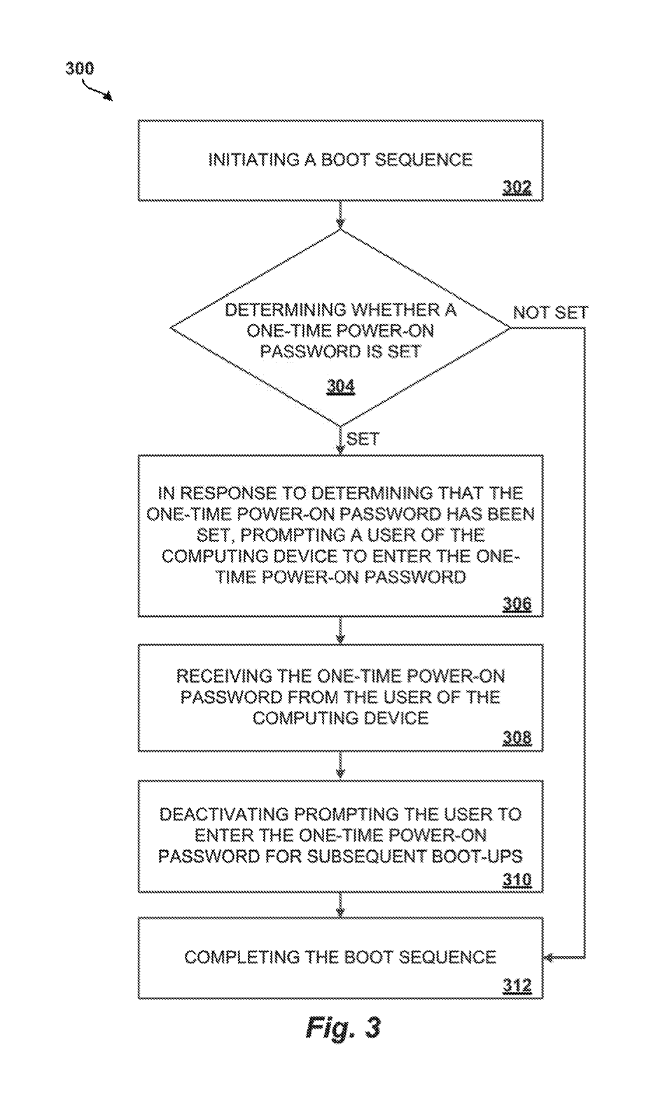

FIG. 3 illustrates a flow diagram of a method 300 for booting a computing device with a one-time power-on password according to examples of the present disclosure. The method 300 may be executed, for example, by a computing system and/or a computing device such as the computing device 100 of FIG. 1.

In one example, the method 300 may include: initiating, by a computing device, a boot sequence (block 302); determining, by the computing device, whether a one-time power-on password is set (block 304); in response to determining that the one-time power-on password has been set prompting, by the computing device, a user of the computing device to enter the one-time power-on password (block 306); receiving, by the computing device, the one-time power-on password from the user of the computing device (block 308); deactivating, by the computing device, the one-time power-on password (block 310); and completing, by the computing device, the boot sequence (block 312).

At block 302, the method 300 may include initiating, by a computing device, a boot sequence. For example, when the computing device is first powered on, a boot loader, such as a BIOS or other appropriate boot loader, may begin a boot sequence. The method 300 may continue to block 304.

At block 304, the method 300 may include determining, by the computing device, whether a one-time power-on password is set. For example, during the boot sequence, the boot loader may determine whether a one-time power-on password is set. This determination may occur as the first or one of the first steps executed by the boot loader. Once it is determined whether a one-time power-on password is set, the method 300 may continue to block 306.

At block 306, the method 300 may include in response to determining that the one-time power-on password has been set, prompting, by the computing device, a user of the computing device to enter the one-time power-on password. If it is determined that the one-time power-on password has been set, the computing device prompts a user of the computing device to enter the one-time power-on password. For example, the computing device may display a prompt or message requesting that the user enters the one-time power-on password on an output device such as a display, screen, or monitor of the computing device. Once the computing device prompts the user to enter the one-time power-on password, the method 300 may continue to block 308.

At block 308, the method 300 may include receiving, by the computing device, the one-time power-on password from the user of the computing device. Once the computing device has prompted the user to enter the one-time power-on password, the user may enter or input the one-time power-on password on the computing device. For example, the user may enter the one-time power-on password on an input device of the computing device such as a keyboard or other appropriate input device. The method 300 may then continue to block 310.

At block 310, the method 300 may include deactivating, by the computing device, prompting the user to enter the one-time power-on password for subsequent boot-ups. Upon receiving the correct one-time power-on password from the user, the computing device may deactivate the one-time power-on password prompt Deactivating the one-time power-on password prompt removes the necessity for entering or inputting the one-time power-on password so that when the computing device powers on and begins the boot sequence at block 302 during subsequent power on events, the computing device will determine that the one-time power-on password is not set at block 304. In one example, once the computing device deactivates the one-time power-on password prompt, if may not prompt the user to enter the password again until reactivated. If an incorrect one-time power-on password is entered, the computing device may prompt the user to reenter the one-time power-on password. After a certain number of unsuccessful attempts to enter the one-time power-on password, such as three attempts, the computing device may turn off or shut down. The method 300 may continue to block 312.

At block 312, the method 300 may include completing, by the computing device, the boot sequence. For example once tie one-time power-on password has been successfully entered and the one-time power-on password has been disabled, the computing device may proceed with and complete the boot sequence. In this case, the boot loader such as a BIOS or other appropriate boot loader may continue to load the suitable drivers, operating system, and other features as appropriate. In one example, if the one-time power-on password has been previously disabled, it may be determined at block 304 that the one-time power-on password is not set (i.e., has been disabled). In this case, the boot sequence may be completed without prompting the user to enter the one-time power-on password (block 306), without receiving the one-time power-on password (block 308), and without deactivating the one-time power-on password (block 310).

Additional processes also may be included, and it should be understood that the processes depicted in FIG. 3 represent illustrations, and that other processes may be added or existing processes may be removed, modified, or rearranged without departing from the scope and spirit of the present disclosure.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of tie present disclosure is intended to cover any and all appropriate combinations and sub-combinations of ail elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A method comprising:
securing a computing device with a one-time power-on password for booting-up the computing device by storing the one-time power-on password in a memory of the computing device; and
providing the one-time power-on password, wherein the one-time power-on password is usable to boot-up a boot loader of the computing device upon the end user entering the one-time power-on password in response to the computing device prompting the end user to enter the one-time power-on password, wherein prompting the user to enter the one-time power-on password is disabled for subsequent boot-up occurrences.

2. The method of claim 1, further comprising:
preventing the computing device from booting up when no one-time power-on password is provided.

3. The method of claim 1, further comprising:
preventing the computing device from booting up when the one-time power-on password is entered incorrectly.

4. The method of claim 1, wherein securing the computing device with the one-time power-on password is performed by a provider of the computing device.

5. The method of claim 1, wherein the one-time power-on password is unique to the computing device.

6. The method of claim 1, wherein the boot loader is a BIOS.

7. A computing device comprising:
a processor;
a memory;
a one-line power-on password module stored in the memory and executable by the processor to store a one-time power-on password for booting-up the computing device, to prompt a user of the computing device to enter the one-time power-on password, and to disable the prompt for subsequent boot-ups when the user enters the one-time power-on password; and
a boot loader module stored in the memory and executable by the processor to boot-up the computing device in response to the user entering the one-time power-on password.

8. The computing device of claim 7, wherein the one-time power-on password is an exclusive password.

9. The computing device of claim 7, wherein the one-time power-on password module prevents the computing device from booting up when the one-time power-on password is entered incorrectly.

10. The computing device of claim 7, further comprising,
a password prompt module stored in the memory and executable by the processor to display a message to prompt the user to enter the one-time power-on password.

11. The computing device of claim 7, wherein the one-time power-on password is unique to the computing device.

12. The computing device of claim 7, wherein the boot loader module is a BIOS.

13. A method comprising;
initiating, by a computing device, a boot sequence;
determining, by the computing device, whether a one-time power-on password is set;
in response to determining that the one-time power-on password has been set, prompting, by the computing device, a user of the computing device to enter the one-time power-on password;
receiving, by the computing device, the one-time power-on password from the user of the computing device;
deactivating, by the computing device, prompting the user to enter the one-time power-on password for subsequent boot-ups; and
completing, by the computing device, the boot sequence.

14. The method of claim 13, further comprising:
in response to determining that the one-time power-on password is not set, completing, by the computing device, the boot sequence.

15. The method of claim 13, further comprising:
in response to receiving an incorrect one-time power-on password from the user of the computing device, powering off the computing device.
